(19) United States
(12) Patent Application Publication
(10) Pub. No.: US 2008/0264348 A1
(43) Pub. Date: Oct. 30, 2008

(54) Puppy Training System

(76) Inventor: Madeleine Gere, Encinitas, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/740,113

(22) Filed: Apr. 25, 2007

(51) Int. Cl. A01K 31/04

(52) U.S. Cl. 119/479

(57) ABSTRACT

An animal training system, the system including: an enclosure; a resting pad disposed within the enclosure; and a latrine tray disposed with the enclosure, the latrine tray containing a receiving material. The receiving material includes wood chips. A method of training an animal, the method including: providing an enclosure, the enclosure having a resting area and a latrine area, the latrine area having a receiving material; keeping the animal in the enclosure for an extended period of time; having the animal learn that the resting area is not for relieving itself of urine and feces; and having the animal learn to use the latrine area for relieving itself of urine and feces.

### BACKGROUND

The present invention relates generally to animal training, and more particularly to methods and systems for latrine training for dogs.

Training a puppy or dog to use a dedicated latrine area is time-consuming and requires constant attention of the animal's owner. Youth and unfamiliarity with a new environment are contributing factors leading to frequent accidents in the home. Further complications arise when no human is available to mind a puppy's needs, such as when the owner must be away at work for several hours a day. Lacking is a humane way to condition a puppy to relieve itself in a designated area, indoor or out, without constant supervision by the owner.

Therefore, what is needed is a system and method that overcomes these significant problems as described above.

### SUMMARY

The present invention provides systems and methods for latrine training an animal such as a puppy or a dog in a confined space.

In an embodiment, an animal training system includes an enclosure, a resting pad disposed within the enclosure, and a latrine tray disposed with the enclosure, the latrine tray containing a receiving material.

In another embodiment, the receiving material includes wood chips.

In yet another embodiment, a method of animal training includes providing an enclosure, the enclosure having a resting area and a latrine area, the latrine area having a receiving material, keeping the animal in the enclosure for an extended period of time, having the animal learn that the resting area is not for relieving itself of urine and feces, and having the animal learn to use the latrine area for relieving itself of urine and feces.

In an embodiment, the extended period of time is up to 8 to 10 hours. In another embodiment, the extended period of time includes at least one break period.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an enclosure according to an embodiment, including a latrine tray and resting pad;

FIG. 2 illustrates a latrine tray according to an embodiment; and

FIG. 3 is a flowchart illustrating an exemplary method of latrine training.

### DETAILED DESCRIPTION

Certain embodiments as disclosed herein provide for a system and method for unsupervised training of an animal to use a designated space to relieve itself of urine and feces. For example, a system as disclosed herein provides for an enclosure including a resting pad and a latrine tray containing a receiving material such as wood chips.

In an embodiment, the latrine tray is filled to a depth of about 2 inches with wood chips and placed in the animal enclosure through an corresponding latrine tray access door in the enclosure. A water dispenser attached to the interior of the enclosure is filled with water. A puppy, for example, may ultimately be left alone in the enclosure up to 8 to 10 hours during day, as well as through the entire night. A chewing material such as a bone, teething bone, or leather toy may also be provided within the enclosure. The puppy will naturally tend to relieve itself in the latrine tray filled with wood chips, and spend other time in the remaining area of the enclosure where the resting pad lay. The puppy will become conditioned to identify the wood chips as a designated area for it to relieve itself. The natural scent of the wood chips, or a scent added to the wood chips, will further strengthen this association. The latrine tray is usually removed daily from the enclosure and excreted matter is removed. The wood chips can also be replaced, such as on a weekly basis. Further, the wood chips can be placed in an outside area in which it is intended for the puppy to eventually relieve itself. Thus, the puppy is trained to relieve itself in areas designated by the placement of woodchips. Significant benefits are realized by owners in the way of freed time for work and other pursuits by not having to constantly mind the puppy's frequent needs. Additionally, the puppy becomes cage-trained, facilitating transport and kenneling. Moreover, the enclosure with the pad, latrine tray, and water dispenser may be used for transporting and kenneling a puppy or dog.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

FIG. 1 illustrates an embodiment of an animal training system 100. The puppy training system 100 includes an enclosure 110, a latrine tray 120, a resting pad 130, and a water dispenser 140. The enclosure 110 further includes a main door 160 and a latrine tray access door 180.

In an embodiment, the enclosure 110 is constructed using a wire mesh of sufficient strength to contain a puppy or older dog. It will be appreciated that other materials may be used to construct the enclosure 110 according to implementation requirements. Other terms describing the enclosure 110 include “crate” and “cage.” The size of the enclosure 110 is typically determined according to the weight of the puppy or dog. It will be appreciated that other measures such as height and length are also determinative of the size of the puppy or dog, and therefore can be used to properly size the enclosure 110 for a particular puppy or dog. It will be further appreciated that the present invention is not limited to use with a puppy or dog, but that it may also be used to train, constrain, maintain, and transport other animals as well.

In an embodiment, one of three enclosure 110 sizes are used to accommodate most puppies or dogs. For example, puppies or dogs weighing less than 30 pounds (lbs) use an enclosure having an interior volume up to about 6 cubic feet (ft³). Puppies or dogs weighing from about 30 lbs to about 80 lbs use an enclosure having an interior volume up to about 14 ft³, and puppies or dogs weighing from about 80 lbs and above use an enclosure having an interior volume up to about 30 ft³.

In another embodiment, one of six enclosure sizes are used for accommodating most puppies or dogs. For example, puppies or dogs weighing less than 15 pounds (lbs) use an enclosure having an interior volume up to about 2.5 cubic feet (ft³). Puppies or dogs weighing from about 15 lbs to about 30 lbs use an enclosure having an interior volume up to about 6 ft³. Puppies or dogs weighing from about 30 lbs to about 50 lbs use an enclosure having an interior volume up to about 8 ft³. Puppies or dogs weighing from about 50 lbs to about 80 lbs use an enclosure having an interior volume up to about 14 ft³. Puppies or dogs weighing from about 80 lbs to about 105 lbs use an enclosure having an interior volume up to about 22 ft³. And, puppies or dogs weighing more than about 105 lbs use an enclosure having an interior volume up to about 30 ft³. It will be appreciated that the volumes associated with various puppy and dog weights are approximate and subject to variation.

In an embodiment, the length (L) is generally about 1.3 to 1.6 times the width (W), and the height (H) is about 1.1 to 1.2 times W. It will be appreciated that other enclosure sizes and relative dimensions may be used according to the needs of a particular implementation by interpolating, extrapolating, and/or modifying the enclosure 110 volumes and dimensions discussed in the foregoing.

In an embodiment, the proportions of the horizontal area (i.e., the “floor”) of the enclosure 110 devoted to the resting area (the area of the enclosure 110 occupied by the resting pad 130) and the latrine area (the area of the enclosure 110 occupied by the latrine tray 120) are about 50% and 50%, respectively. In another embodiment, the proportions are 50-70% and 50-30%, respectively. In another embodiment, the proportions are 60-80% and 40-20%, respectively.

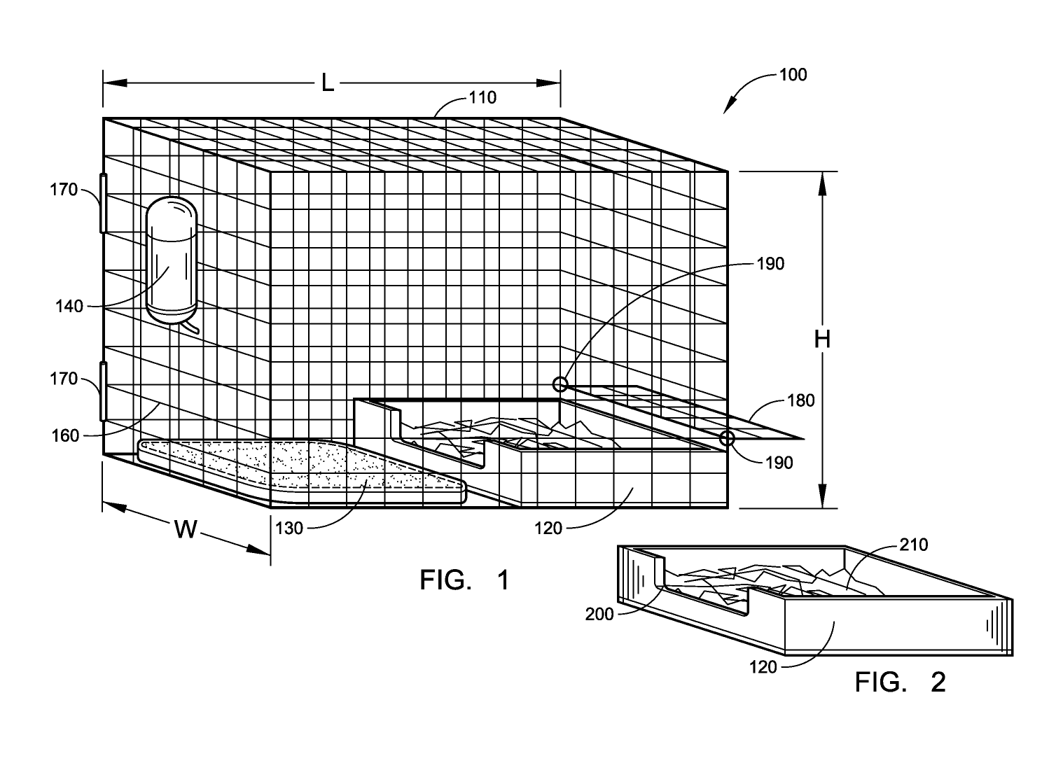

In the example illustrated in FIG. 1, the latrine tray 120 and the resting pad 130 together occupy substantially all of the floor space (i.e., the bottom) of the enclosure 110. This arrangement of the latrine tray 120 and the resting pad 130 provides a designated area for the puppy or dog to relieve itself, and a separate area designated for play and rest. The dog or puppy will naturally tend to use these two areas as described. The latrine tray 120 is described in more detail in relation to FIG. 2.

A main door 160 is disposed at one end of the enclosure 110. The main door 160 is coupled to the enclosure 110 by hinges 170. As depicted, the main door 160 swings outwardly on a vertical axis. In an embodiment, the main door 160 and hinges 170 are configured such that the main door 160 swings up on a horizontal axis. In another embodiment, the main door 160 and hinges 170 are configured such that the main door 160 swings down on a horizontal axis. In an embodiment, the main door is configured to fit within a frame inset in a side of the enclosure 110, for example, proximate to the resting pad 130. One or more latches (not shown) are typically used to maintain the main door 160 in a closed position. It will be appreciated that other mechanisms can be used to implement a main door 160, including, but not limited to, sliding and removable doors.

A water dispenser 140 is shown coupled to the main door 160. In other embodiments, the water dispenser 140 is disposed elsewhere on the enclosure 110, typically proximate to the resting pad 130.

In the embodiment shown in FIG. 1, a latrine tray access door 180 is disposed at the end of the enclosure 110 opposite to the main door 160. The latrine tray access door 180 is coupled to the enclosure 110 with hinges 190. The hinges 190 configured as shown allow the latrine tray access door 180 to swing upwardly, permitting access to the latrine tray 120 for maintenance. One or more latches (not shown) are used to maintain the latrine tray access door 180 in a closed position. One or more latches (not shown) are also used to maintain the latrine tray access door 180 in an open position to facilitate placing the latrine tray 120 in the enclosure 110 and removing the latrine tray 120 from the enclosure 110. It will be appreciated that other mechanisms can be used to implement a latrine tray access door 180, including, but not limited to, sliding and removable doors. In an embodiment, the latrine tray access door 180 is disposed on the front of the enclosure 110 in similar fashion. In another embodiment, the latrine tray access door 180 is similarly disposed on the back of the enclosure 110.

The enclosure 110 provides “crate training” and “kennel training.” In an embodiment, the enclosure 110 functions as a travel crate for the puppy or dog, providing for its basic needs for water and a latrine area, as well as providing a familiar environment in which the puppy or dog has become accustomed to remaining for extended periods of time. Generally, a puppy or dog may be left unsupervised in the enclosure 110 with water and the latrine tray for up to 8 to 10 hours, preferably with occasional play breaks. A puppy or dog may also be left unsupervised in the enclosure 110 with water and the latrine tray during the entire night. Moreover, the enclosure 110 provides a safe and secure environment for a puppy or dog, keeping the puppy or dog out of trouble in the home. The owner may therefore leave the premises and go about business, having been relieved of the need to constantly mind the puppy's or dog's needs. In another embodiment, the enclosure 110 is put to daily use by handlers for maintenance and control of many types of animals.

In another embodiment, the animal training system 100 is used for crate training of the puppy or dog, useful for transporting and kenneling the puppy or dog.

FIG. 2 illustrates a latrine tray 120 according an embodiment. As shown, the latrine tray 120 includes an ingress-egress relief 200, and contains a receiving material 210.

In an embodiment, the latrine tray 120 has a height of about 3 inches to allow a puppy or dog to step easily into the latrine tray 120. In an embodiment, the ingress-egress relief 200 is provided in a side of the latrine tray 120 to further accommodate a smaller puppy's or dog's access to the latrine tray 120.

The latrine tray 120 contains a receiving material 210, onto which the puppy or dog relieves itself of urine and feces. The receiving material 210 also provides the puppy or dog with a consistent element onto which to perform these bodily functions, leading the puppy or dog to associate the receiving material 210 with a designated area for these needs.

As discussed in the foregoing, a puppy or dog will naturally perform its bodily functions in a different area than in which it plays, rests, and eats. In an embodiment, the receiving material 210 is a wood-based material, including such materials as wood chips and bark chips (referred hereinafter generally as “wood chips”). The wood chips 210 further include cedar chips and redwood chips. Wood chips 210 provide an earthy scent that fosters in the puppy or dog its natural preference for using them for latrine needs. Moreover, training the puppy or dog to identify wood chips 210 with a designated relief area likewise de-associates areas having other materials such as cloth or carpeting, for example, for latrine needs. Thus, the puppy or dog becomes imprinted to relieve itself outdoors even while constrained with the enclosure 110. In an embodiment, the wood chips 210 are imbued with one or more scents to further interest the puppy or dog in using the wood chips 210 for its bodily needs.

In an embodiment, once the puppy or dog has learned to associate the wood chips 210 with a designated area for bodily relief, the latrine tray 120 with the wood chips 210 is then placed in another area of the puppy's or dog's environment to designate a latrine area. For example, old wood chips 210 removed from the latrine tray 120 during cleaning are disposed in an area of a yard where the puppy or dog is allowed to play. The puppy or dog seeks the old wood chips for its latrine needs, and further learns that the area of the yard is the latrine area in which it is expected to relieve itself. Further, the latrine tray 120 also functions externally from the enclosure 110 in a stand-alone mode. In an embodiment, the latrine tray 120 is placed in a particular room of the home, and a puppy or dog learns that it is expected to perform its bodily functions in the latrine tray 120 in that room, and not elsewhere in the home. In another embodiment, the latrine tray 120 with the wood chips 210 is located in an outdoor area such as a porch, deck, or balcony, for example.

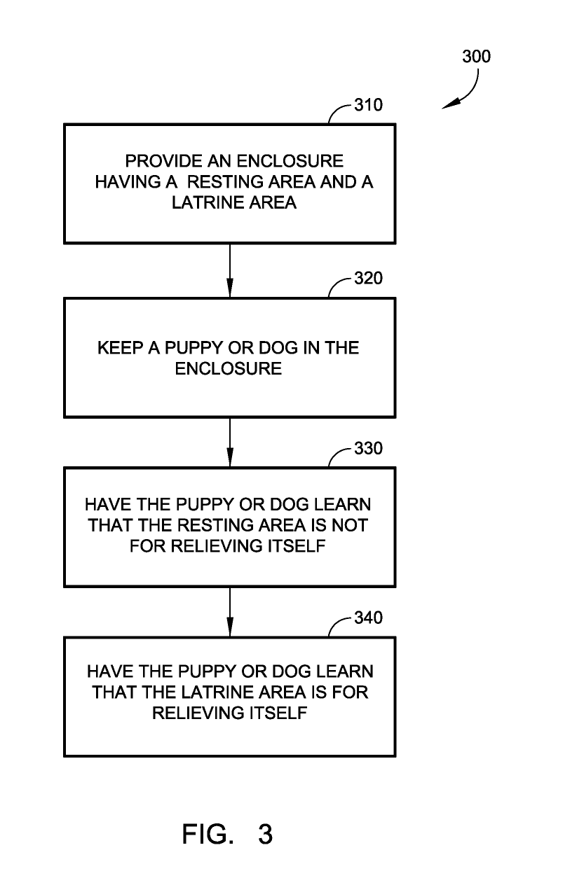

FIG. 3 is a flowchart depicting a latrine training method 300 for a puppy or dog according to an embodiment.

An enclosure is provided at 310, the enclosure having a resting area and a latrine area, and the latrine area having a receiving material. The puppy or dog is kept in the enclosure, at 320. Usually, the puppy or dog is kept in the enclosure for an extended period of time. The puppy or dog uses the resting area and learns that that the resting area is not for relieving itself of urine and feces, at 330. The puppy or dog uses the latrine area and learns that the latrine area is for relieving itself, at 340. The puppy or dog is naturally inclined to use the latrine area for its bodily relief needs due in part to the earthy scent of the receiving material, which includes wood-based materials including wood chips and bark chips. In an embodiment, the receiving material includes cedar chips. In another embodiment, the receiving material includes redwood chips. The puppy or dog is likewise disinclined to relieve itself in the resting area where it spends other time. In another embodiment, the receiving material is scented to further encourage the puppy or dog to use the latrine area for relieving itself.

In an embodiment, the extended period of time over which the puppy or dog is kept in the enclosure includes up to 8 to 10 hours, and can include a break period for exercise and play. The extended period of time includes overnight, for example, corresponding with normal sleeping hours of the owner, the puppy or dog, or a training facility in which the latrine training is taking place.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent embodiments of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1-16. (canceled)

17. A method of training an animal, comprising:
providing an enclosure, the enclosure having a resting area and a latrine area, the latrine area having a receiving material;
keeping the animal in the enclosure for an extended period of time;
having the animal learn that the resting area is not for relieving itself of urine and feces; and
having the animal learn to use the latrine area for relieving itself of urine and feces.

18. The method of claim 17, wherein said receiving material includes a wood-based material.

19. The method of claim 17, wherein said extended period of time is up to 8 to 10 hours.

20. The method of claim 17, wherein said extended period of time includes at least one break period.

21. The method of claim 17, wherein providing an enclosure includes providing an enclosure that further includes an access door proximate to the latrine tray, the size of the access door providing for passage of the latrine tray through the access door.

22. The method of claim 17, wherein providing an enclosure includes providing an enclosure that further includes a main door, the size of the main door providing for passage of an animal into and out of the enclosure.

23. The method of claim 17, wherein providing an enclosure includes providing an enclosure wherein the enclosure has a volume up to about 6 cubic feet to accommodate an animal weighing less than about 30 pounds; the enclosure has a volume up to about 14 cubic feet to accommodate an animal weighing from about 30 pounds to about 80 pounds; and the enclosure has a volume up to about 30 cubic feet to accommodate an animal weighing more than about 80 pounds.

24. The method of claim 17, wherein providing an enclosure includes providing an enclosure wherein the enclosure has a volume up to about 2.5 cubic feet to accommodate an animal weighing less than about 15 pounds; the enclosure has a volume up to about 6 cubic feet to accommodate an animal weighing from about 15 pounds to about 30 pounds; the enclosure has a volume up to about 8 cubic feet to accommodate an animal weighing from about 30 pounds to about 50 pounds; the enclosure has a volume up to about 14 cubic feet to accommodate an animal weighing from about 50 pounds to about 80 pounds; the enclosure has a volume up to about 22 cubic feet to accommodate an animal weighing from about 80 pounds to about 105 pounds; and the enclosure has a volume up to about 30 cubic feet to accommodate an animal weighing more than about 105 pounds.

25. The method of claim 17, wherein providing an enclosure includes providing an enclosure wherein the enclosure has a length about 1.3 to 1.6 times the width; and the enclosure has a height about 1.1 to 1.2 times the width.

26. The method of claim 17, wherein providing an enclosure includes providing an enclosure wherein the resting pad occupies 50 to 70 percent of a horizontal area of the enclosure; and the latrine tray occupies respectively 50 to 30 percent of the horizontal area of the enclosure.

27. The method of claim 17, wherein providing an enclosure includes providing an enclosure wherein the resting pad occupies 60 to 80 percent of a horizontal area of the enclosure; and the latrine tray occupies respectively 40 to 20 percent of the horizontal area of the enclosure.

28. The method of claim 17, wherein the wood-based material includes cedar chips.

29. The method of claim 17, wherein the wood-based material includes redwood chips.

30. The method of claim 17, wherein providing an enclosure includes providing an enclosure wherein the receiving material is scented.

31. The method of claim 17, wherein providing an enclosure includes providing an enclosure wherein the receiving material fills the latrine tray to a depth of about 2 inches.

32. The method of claim 17, wherein providing an enclosure includes providing an enclosure wherein the latrine tray is about 3 inches tall.

33. The method of claim 17, wherein providing an enclosure includes providing an enclosure wherein the latrine box includes at least one ingress/egress relief disposed on a side of the latrine tray.

34. The method of claim 17, wherein providing an enclosure includes providing an enclosure further comprising a water dispenser.
